(19) United States
(12) Patent Application Publication
(10) Pub. No.: US 2008/0302970 A1
(43) Pub. Date: Dec. 11, 2008

(54) RADIATION RAY DETECTOR

(75) Inventors: Shinetsu Fujieda, Kawasaki-shi (JP); Hiroko Watando, Yokohama-shi (JP); Akinori Honguu, Fujisawa-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/038,596

(22) Filed: Feb. 27, 2008

(30) Foreign Application Priority Data
Mar. 1, 2007 (JP) 2007-051793

(51) Int. Cl. G01T 1/20

(52) U.S. Cl. 250/370.11

(57) ABSTRACT

A radiation ray detector includes an electrode substrate includes a transparent substrate, a plurality of thin film transistors and a plurality of collecting capacitors formed on the transparent substrate, respectively, an insulation layer formed on the transparent substrate including these thin film transistors and collecting capacitors, and a plurality of photoelectric conversion elements connected to respective thin film transistors and converting visible light into an electrical signal. A scintillator layer is formed on the electrode substrate. A protective layer comprises a reflective layer formed on the scintillator layer and containing a thermoplastic polymer compound and a titanium oxide powder contained therein in an amount of 70 wt % or more, an adhesive layer formed on the surface of the electrode substrate including the reflective layer, and a moisture-proof layer adhered to the adhesive layer and having a moisture transmittance of 0.5 g/m²/day or less at 40° C. and 90% RH.

### CROSS-REFERENCE TO RELATED APPLICATIONS

This application is based upon and claims the benefit of priority from prior Japanese Patent Application No. 2007-051793, filed Mar. 1, 2007, the entire contents of which are incorporated herein by reference.

### BACKGROUND OF THE INVENTION

1. Field of the Invention

The present invention relates to a radiation ray detector, and particularly to a radiation ray detector converting incident radiation rays into electrical signals by an indirect system.

2. Description of the Related Art

Active-matrix plane detectors have been developed as new-generation image detectors for X-ray diagnosis. In such a plane detector, an X-ray image or a real-time X-ray image is output as a digital signal by detection of irradiated X-rays.

Plane detectors of this kind are roughly classified into two: direct and indirect systems. The direct system is a system obtaining an image by converting X-rays directly into an electric charge signal with an X-ray-converting film. On the other hand, the indirect system is a system obtaining an image by turning X-rays into visible light with a scintillator layer and converting the visible light into an electric charge signal with a photoelectric conversion element such as an amorphous silicon (a-Si) photodiode or charge coupled device (CCD).

A material such as cesium chloride:sodium (CsI:Na), cesium chloride:thallium (CsI:Tl), sodium iodide (NaI), or gadolinium oxide sulfide (Gd₂O₂S) has been used for the scintillator layer incorporated in the plane detector of the indirect system. For improvement in resolution properties, the scintillator layer is often made to have a columnar structure by either forming grooves thereof for example by dicing or depositing the layer in the columnar structure. However, the materials for use as the scintillator layer are often very hygroscopic and show deterioration in properties such as sensitivity and resolution, when left under an atmospheric environment.

For this reason, for prevention of deterioration in the properties of the scintillator layer incorporated in an indirect-system plane detector, a protective layer effective in shielding air and moisture, while allowing transmission of X-rays may be used. For example, JP-A 5-39558 (KOUKOKU) discloses use of an organic film such as a xylylene resin formed by a vapor deposition method under a vacuum or inactive gas atmosphere as a protective layer. JP-A 6-58440 (KOUKOKU) discloses use of an inorganic film such as of silicon oxide nitride as the protective layer.

However, the protective layer obtained by the vapor deposition method described in JP-A 5-39558 (KOUKOKU) requires an extended period of time for film formation and also an expensive vapor deposition apparatus. In addition, the resin is structurally rigid, and thus less adhesive to a substrate, possibly causing separation because of the difference in thermal expansion coefficient. Lower adhesive strength between the resin protective layer and the substrate leads to increase of the moisture transmittance at the edge of the protective layer, making it difficult to prevent deterioration in properties such as sensitivity and resolution for an extended period of time. In addition, although a protective layer of organic film has fewer defects such as pinholes and is resistant to cracking even if it is thin, immediately after preparation, there is a concern that such an organic film may have more defects such as pinholes and have larger moisture transmittance due to softening and denaturation of the organic film when it is processed at a temperature higher than its glass transition temperature (Tg) during assembly of an X-ray detector. Further, when the vapor deposition method is used with a resin, the resin deposits in the openings between the columnar crystals of the scintillator layer, making the refractive index ratio of columnar crystal to opening close to 1. As a result, the reflection efficiency of the columnar crystal declines, making it difficult to obtain a plane detector having high stabilized sensitivity and resolution for an extended period of time.

In contrast, the protective layer of an inorganic film described in JP-A 6-58440 (KOUKOKU), which has a higher glass transition temperature (Tg), can prevent defect generation by high-temperature processing. However, such a thin film is lower in mechanical strength, easily resulting in cracking.

### BRIEF SUMMARY OF THE INVENTION

According to a first aspect of the present invention, there is provided a radiation ray detector comprising:

an electrode substrate comprising a transparent substrate, a plurality of thin film transistors formed on the transparent substrate, a plurality of collecting capacitors formed on the transparent substrate, respectively, an insulation layer formed on the transparent substrate including these thin film transistors and collecting capacitors, and a plurality of photoelectric conversion elements connected to respective thin film transistors and converting visible light into an electrical signal;

a scintillator layer formed on the electrode substrate to convert radiation rays into visible light; and

a protective layer comprising at least a reflective layer formed on the scintillator layer and containing a thermoplastic polymer compound and a titanium oxide powder contained therein in an amount of 70 wt % or more, an adhesive layer formed on the surface of the electrode substrate including the reflective layer, and a moisture-proof layer adhered to the adhesive layer and having a moisture transmittance of 0.5 g/m²/day or less at 40° C. and 90% RH.

According to a second aspect of the present invention, there is provided a radiation ray detector comprising:

an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;

a scintillator layer formed on the electrode substrate to convert radiation rays into visible light; and

a protective layer comprising at least a reflective layer formed on the scintillator layer and containing a thermoplastic polymer compound and a titanium oxide powder contained therein in an amount of 70 wt % or more, a frame-shaped adhesive layer bonded to the reflective layer on the surface of the electrode substrate surface and the side wall of the scintillator, and a moisture-proof layer having a moisture transmittance of 0.5 g/m²/day or less at 40° C. and 90% RH adhered to the frame-shaped adhesive layer.

According to a third aspect of the present invention, there is provided a radiation ray detector comprising:

an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;

a scintillator layer formed on the electrode substrate to convert radiation rays into visible light; and

a protective layer comprising an adhesive layer to be adhered to the electrode substrate including the scintillator layer, a reflective layer adhered to the adhesive layer and containing a thermoplastic polymer compound and a titanium oxide powder contained therein in an amount of 70 wt % or more, and a moisture-proof layer laminated to the reflective layer and having a moisture transmittance of 0.5 g/m²/day or less at 40° C. and 90% RH.

According to a fourth aspect of the present invention, there is provided a radiation ray detector comprising:

an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;

a scintillator layer formed on the electrode substrate to convert radiation rays into visible light; and

a protective layer comprising a frame-shaped adhesive layer adhered to the surface of the electrode substrate and the side wall of the scintillator layer, a reflective layer adhered to the adhesive layer, containing a thermoplastic polymer compound and a titanium oxide powder contained therein in an amount of 70 wt % or more, and a moisture-proof layer laminated onto the reflective layer and having a moisture transmittance of 0.5 g/m²/day or less at 40° C. and 90% RH.

### BRIEF DESCRIPTION OF THE SEVERAL VIEWS OF THE DRAWING

FIG. 1 is a sectional view illustrating the major components of a radiation ray detector (X-ray detector) in a first embodiment;

FIG. 2 is a schematic sectional view illustrating a step of forming a protective layer of the X-ray detector shown in FIG. 1;

FIG. 3 is a schematic sectional view illustrating the step of forming the protective layer of the X-ray detector in a second embodiment;

FIG. 4 is a schematic sectional view illustrating the step of forming the protective layer of the X-ray detector in a third embodiment;

FIG. 5 is a schematic sectional view illustrating the step of forming the protective layer of the X-ray detector in a fourth embodiment; and

FIG. 6 is a schematic sectional view illustrating the step of forming the protective layer of the X-ray detector in a modified fourth embodiment.

### DETAILED DESCRIPTION OF THE INVENTION

Hereinafter, radiation ray detectors in embodiments of the present invention will be described with reference to drawings.

### First Embodiment

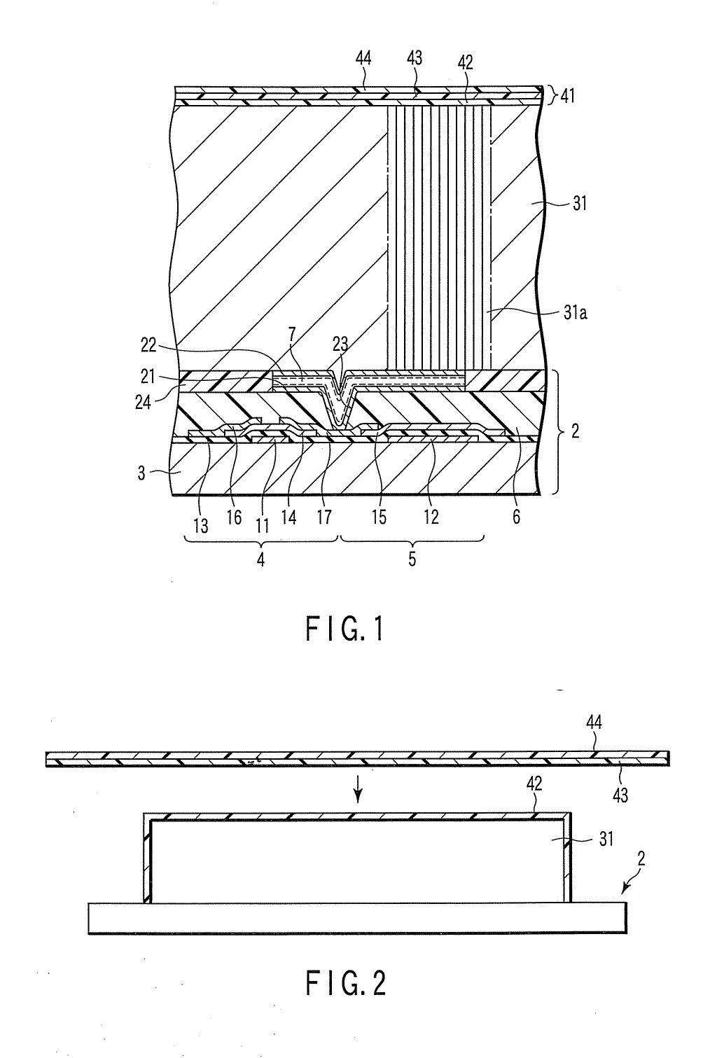

FIG. 1 is a sectional view illustrating the major components of an X-ray detector of an indirect conversion system, i.e., a radiation ray detector in a first embodiment, and FIG. 2 is a schematic sectional view illustrating a step of forming a protective layer of the X-ray detector of FIG. 1.

An X-ray detector 1 in the indirect conversion system has an active matrix photoconverting substrate 2 as an electrode substrate. The photoelectric converting substrate 2 comprises, for example, a transparent substrate (glass plate) 3 (Corning 1737, trade name, manufactured by Corning Incorporated), a plurality of thin film transistors 4 and a plurality of rectangular planer collecting capacitors 5 formed in a matrix on one main face of the glass plate 3 functioning as switching elements, respectively, an insulation layer (flattened resin layer) 6 formed on these thin film transistors 4 and collecting capacitors 5, and photoelectric conversion elements, for example photodiodes 7, converting visible light into an electrical signal formed on the flattened resin layer 6 as they are connected to the respective thin film transistors 4.

The thin film transistor 4 has a gate electrode 11 formed on the glass plate 3, and the collecting capacitor 5 has a first electrode 12 formed on the glass plate 3. The insulation film 13 functioning both as a gate insulation film and a dielectric film is formed on the entire surface of the glass plate 3 including the electrodes 11 and 12. For example, an active layer 14 of an impurity-doped polycrystalline silicon is formed on the insulation film 13 at a position facing the gate electrode 11. A second electrode 15 of an impurity-doped polycrystalline silicon is formed on the insulation film 13 at a position facing the first electrode 12. A source electrode 16 is formed on the insulation film 13 so as to overlap one terminal of the active layer 14 (e.g., left terminal). A drain electrode 17 is formed on the insulation film 13 so as to overlap the other terminal of the active layer 14 (e.g., right terminal) and one terminal of the second electrode 15 (e.g., left terminal). The flattened resin layer 6 is formed over the entire surface of the insulation film 13 including the active layer 14, the second electrode 15, the source electrode 16 and the drain electrode 17.

The photodiode 7 is formed on each pixel on the flattened resin layer 6 as amorphous silicon (a-Si) in the pn or pin diode structure. The photodiode 7 has a charge-collecting electrode 21 as the first electrode and, for example, an ITO (Indium-Tin Oxide) bias electrode 22 as the second electrode. The charge-collecting electrode 21 is connected to the drain electrode 17 through a throughhole 23 in the flattened resin layer 6. The bias electrode 22 generates a bias electric field with the charge-collecting electrode 21, when a bias voltage is applied. An insulation resin layer 24 is formed on the flattened resin layer 6 excluding the photodiode 7, the charge-collecting electrode 21, and the bias electrode 22 in such a manner that the insulation layer 24 has the same plane with the bias electrode 22.

A long rectangular plate-shaped high-speed signal processing unit (not shown in the figure) for control of the operational state of each thin film transistor 4, for example for control of on/off of each thin film transistor 4, is placed on one side of the glass plate 3 in the row direction of the surface. The high-speed signal processing unit is a line driver for controlling the signal read out and processing of the read signal. Terminals of a plurality of control lines (not shown in the figure) are electrically connected to the high-speed signal processing unit. Each control line is wired in the row direction of the glass plate 3 so as to be located between pixels. Each control line is also electrically connected to the gate electrode 11 of each thin film transistor 4 constituting the pixels on the same row.

On the surface of the glass plate 3, a plurality of data lines (not shown in the figure) are wired along the column direction so as to be located between pixels. Each data line is electrically connected to the source electrode 16 of the thin film transistor 4 constituting the pixels on the same column, and receives the image data signal from the thin film transistor 4 constituting the pixels on the same column. One terminal of each data line is further electrically connected to the high-speed signal processing unit, and the high-speed signal processing unit is further electrically connected to a digital image-transmitting unit (not shown in the figure) functioning as a digital image-processing unit. The digital image-transmitting unit is derived to the outside of the photoelectric converting substrate 2.

A scintillator layer 31 converting incident X-rays into visible light is formed on the insulation resin layer 24 including the bias electrode 22. The scintillator layer 31 is a columnar crystal formed by depositing a phosphor such as sodium iodide (NaI) or cesium chloride (CsI) on individual columnar structures 31a for example by vapor deposition, electron beam or sputtering. Accordingly, the scintillator layer 31 is resistant to diffusion of the light generated by the columnar crystal and thus, has high resolution.

A protective layer 41 effective in shielding air and moisture but allowing transmission of X-rays is formed on the surface of the photoelectric converting substrate 2 including the surface and side wall of the scintillator layer 31. The protective layer 41 has a reflective layer 42, containing a thermoplastic polymer compound and a titanium oxide powder contained therein in an amount of 70 wt % or more that is formed on the surface and side wall of the scintillator layer 31, an adhesive layer 43 adhered to the reflective layer 42, and a moisture-proof layer 44 having a moisture transmittance of 0.5 g/m²/day or less at 40° C. and 90% RH that is laminated to the adhesive layer 43.

Such a protective layer 41 is prepared, for example, by the following method. First, a paint for a reflective layer, an solution containing a titanium oxide powder in an amount of 70 wt % or more in a thermoplastic polymer compound dissolved in an organic solvent, is prepared. A reflective layer 42 is formed by coating the paint for the reflective layer, for example on surface and side wall of the scintillator layer 31 in advance, as shown in FIG. 2. A moisture-proof layer 44 having an adhesive layer 43 on one face is then made available, and the protective layer 41 is formed by bonding the adhesive layer 43 of the moisture-proof layer 44 onto the surface of the photoelectric converting substrate 2 carrying the reflective layer 42.

The reflective layer 42, the adhesive layer 43 and the moisture-proof layer 44 for the protective layer 41 will be described below separately in detail.

(Reflective Layer)

The reflective layer has a function to reflect the visible light generated by the irradiation of radiation rays (e.g., X-rays) into the scintillator layer 31 toward the photodiode 7, and has a composition of a thermoplastic polymer compound and a titanium oxide powder contained therein in an amount of 70 wt % or more. The titanium oxide powder functions as a reflection material that reflects the visible light generated by radiation of radiation rays (e.g., X-rays) into the scintillator layer 31, while absorbing or transmitting the radiation rays (e.g., X-rays) without reflection. Accordingly, a protective layer 41 having a reflective layer 42 containing the titanium oxide powder shows high permeability to the radiation rays (e.g., X-rays).

Examples of the thermoplastic polymer compounds include butyral resins, polyester resins, acrylic resins, styrene resins, silicone resins, and epoxy resins.

The titanium oxide powder preferably has an average diameter of 0.1 to 1 μm. The titanium oxide powder preferably has its surface coated with alumina or a combination of alumina and an organic material. Such a surface-treated titanium oxide powder prevents degradation of the thermoplastic polymer compound.

A titanium oxide powdery content in the thermoplastic polymer compound of 70 wt % or less may lead to deterioration of the reflectivity to visible light.

The upper limit of the titanium oxide powder content is preferably 95 wt % or less, considering adhesion (adhesiveness) to the scintillator layer 31.

The reflective layer preferably has a thickness of 50 to 800 μm.

For example, in preparing the paint for reflective layer to form the reflective layer, a thermoplastic polymer compound is dissolved in a solvent; a titanium oxide powder is added to the solution in a certain amount; and the mixture is then pre-agitated, for example, in a rotational/revolutional mixer and agitated thoroughly in a homogenizer, three-roll mill, sand mill, or the like into a homogeneous dispersion.

(Adhesive Layer)

A common bonding or adhesive agent may be used in forming the adhesive layer. Typical examples thereof include acrylic adhesives, silicone-based adhesives, rubber-based adhesives such as vinyl acetate adhesives, epoxy resin adhesives, phenol resin adhesives, and polyimide resin adhesives. Among them, considering large-scale X-ray detectors, the adhesive layer is preferably formed with a low-modulus bonding agent or adhesive, for example an adhesive effective at room temperature, such as an acrylic adhesive, silicone-based adhesive or butyl rubber-based adhesive.

A crushed, spherical, semi-spherical, or scaly inorganic component (in particular, spherical or semi-spherical inorganic component having an average diameter of 10 μm or less, considering the surface smoothness) may be added to the adhesive layer for preventing penetration of moisture from the terminal, adjusting the moisture-shielding efficiency and the thermal expansion coefficient of the resin component and also for improving film performance. In addition, a fibrous inorganic component may be added thereto for improvement of the cracking resistance.

Examples of the crushed or other inorganic components include fused silica, crystalline silica, glass, talc, alumina, calcium silicate, calcium carbonate, barium sulfate, magnesia, silicon nitride, boron nitride, aluminum nitride, magnesium oxide, beryllium oxide, mica, and the like. Among these inorganic components, fused silica or crystalline silica is preferable.

Examples of the fibrous inorganic components include titania, aluminum borate, silicon carbide, silicon nitride, potassium titanate, basic magnesium, zinc oxide, graphite, magnesia, calcium sulfate, magnesium borate, titanium diboride, α-alumina, chrysotile, whiskers such as wollastonite, amorphous fibers such as E-glass fiber, silica alumina fiber, and silica glass fiber; crystalline fibers such as tilano fiber, silicon carbide fiber, zirconia fiber, γ-alumina fiber, α-alumina fiber, PAN-based carbon fiber, and pitch-based carbon fiber; and the like. The fibrous inorganic component preferably has an average fiber diameter of 5 μm or less and a maximum fiber length of 10 μm or less for uniformity of the coated film surface.

The inorganic component is preferably blended in an amount in the range of 0.1 to 50 wt % based on the total amount of the resin and inorganic components. When the blending amount of the inorganic component is less than 0.1 wt %, it may lead to excessive enlargement of the thermal expansion coefficient of the adhesive layer and consequently to reduced improvement in thermal shock resistance. On the other hand, when the blending amount of the inorganic component is more than 50 wt %, it leads to insufficient flowability of the adhesive layer and deterioration in processability, possibly causing void generation and thus making it difficult to obtain a protective layer having a uniform thickness.

In the case of an adhesive layer containing a high-modulus resin component, a thermoplastic resin, rubber component, and various oligomers may be added thereto to reduce the modulus of the adhesive layer for improvement in cracking resistance of the resulting X-ray detector during a temperature cycle test. Examples of the thermoplastic resins include butyral resins, polyamide resins, aromatic polyester resins, phenoxy resins, MBS resins, ABS resins, silicone oils, silicone resins, silicone rubbers, fluorine rubbers, and the like.

In addition, various plastic or engineering plastic powders, for example, may be added to the adhesive layer. Further, various other additives such as an adhesiveness improver, water repellent agent, oil repellent agent, insecticide, ultraviolet absorbent, antibacterial agent, antistatic agent, paint fixing agent, anticockling agent, antioxidant, surfactant, coupling agent, and colorant may be added to and blended in the adhesive layer for further improvement in adhesiveness.

In blending inorganic components in the resin component, inorganic components are added to the resin component; a solvent is added as needed; and the mixture may be agitated uniformly in a three-roll mill, ball mill, sand mill, mortar, homogenizer, rotational/revolutional mixer, universal mixer, extruder, Henschel mixer, or the like, to homogeneity.

(Moisture-Proof Layer)

The moisture-proof layer characteristically has a moisture transmittance of 0.5 g/m²/day or less at 40° C. and 90% RH, and for example, an inorganic material-deposited resin film may be used.

The film base material is preferably a thermoplastic resin such as polyethylene terephthalate, polyethylene, polypropylene, polyvinylalcohol (PVA), or polychloro-trifluoroethylene (PCTFE). An alloyed resin may also be used as the film based material.

The inorganic material for use in the inorganic material-deposited layer is preferably, for example, silicon dioxide (SiO₂), aluminum oxide (Al₂O₃), or silicon nitride (Si₃N₄).

Typical examples of the inorganic material-deposited resin films include Techbarrier films V, P2, H, T, TZ, NY, NR, and S carrying a silica-deposited film (all, trade name, manufactured by Mitsubishi Plastics, Inc.), GL films GL-AU, GL-AE, GL-AEH, GL-AEY, and GL-AEO carrying an alumina-deposited film and an alumina-deposited GX film GX (all, trade name, manufactured by Toppan Printing Co., Ltd.), and GL film GL-E carrying a silica-deposited film (trade name, manufactured by Toppan Printing Co., Ltd.).

The moisture-proof layer may be used as it is laminated with the inorganic material-deposited resin film.

The moisture-proof layer preferably has a thickness of 10 to 500 μm.

The multilayered film above is formed, for example, by a method of coating the bonding agent on the moisture-proof layer by screen printing, metal screen printing, dispensing, crimping, dipping, brushing, roller coating, flow coating, or other spray coating, by using a die coater, knife coater, spin coater, curtain flow coater, reverse coater, or the like and then drying the coated film. The coated film may be dried, for example, by air-drying, draft drying, heating drying, vacuum drying, microwave drying, or ultrasonic drying.

Hereinafter, the operation of the X-ray detector in the first embodiment will be described.

First, X-rays penetrate through the protective layer 41 into the scintillator layer 31 and generates visible light in the scintillator layer 31. The visible light is emitted toward the protective layer 41 and the photodiode 7. The protective layer 41, which has a reflective layer 42 containing titanium oxide powder in a thermoplastic polymer compound in an amount of 70 wt % or more, reflects the visible light by the reflective layer 42 and redirects the light toward the photodiode 7. The visible light is photoelectrically converted in the photodiode 7. When a bias electric field is generated to the charge-collecting electrode 21 while a bias voltage is applied to the bias electrode 22 located on the top sandwiching a photodiode 7 therebetween, the electric charge generated in the photodiode 7 (signal electric charge) moves to the charge-collecting electrode 21 and is collected in the collecting capacitor 5, for example, through the drain electrode 17 from the charge-collecting electrode 21.

The signal electric charge thus collected in the collecting capacitor 5 is read by a high-speed signal processing unit not shown in the figures, as it is controlled, for example, in order of pixel units on each row.

Specifically, an “on” signal, for example of 10 V, is input from the high-speed signal processing unit through a data line not shown in the figures to the gate electrode 11 in a pixel unit located on the first row, turning on the thin film transistor 4 in the pixel unit on the first row. The signal charge collected in the collecting capacitor 5 of the pixel unit on the first row when the thin film transistor 4 is turned on is output from the drain electrode 17 to the source electrode 16 as an electrical signal. The electrical signal output to the source electrode 16 is amplified in the high-speed signal processing unit. The amplified electrical signal is output to the digital image-transmitting unit (not shown in the figure), where it is converted into a serial signal and then into a digital signal and sent to the signal processing circuit in the next row not shown in the figure.

After the electric charge from the collecting capacitor 5 in the pixel unit located on the first row is read out, an “off” signal for example of −5 V is input to the gate electrode 11 in the pixel unit on the first row from the high-speed signal processing unit through a data line, turning off the thin film transistor 4 in the pixel unit on the first row.

Then, the operations described above are repeated on the second and other rows continuously. Electrical signals corresponding to one X-ray image plane are output from the digital image-transmitting unit not shown in the figures, after the signal electric charges collected in the collecting capacitors 5 of all pixel units are read, converted sequentially to digital signals, and output.

As described above, according to the first embodiment, it is possible to prevent penetration of moisture into a scintillator layer 31, by forming a layered protective layer 41 comprising a reflective layer 42, an adhesive layer 43, and a moisture-proof layer 44 superior in moisture resistance having a moisture transmittance of 0.5 g/m²/day or less at 40° C. and 90% RH formed in that order on an electrode substrate (photoconverting substrate) 2 including a scintillator layer 31 of an X-ray detector 1. In particular, it is possible to prevent penetration of moisture form the terminal side wall of the protective layer 41 into the scintillator layer 31 by forming the reflective layer 42 on the surface and side wall of the scintillator layer 31 and the adhesive layer 43 over the surface of the reflective layer 42 to the photoconverting substrate 2. It is also possible to make the protective layer adhere to the photoconverting substrate 2 and prevent penetration of moisture from the terminal side wall of the protective layer into the scintillator layer 31 more reliably, by using an acrylic adhesive, silicone-based adhesive or butyl rubber-based adhesive tacky at room temperature as the adhesive layer 43.

It is also possible to improve the photoelectric conversion efficiency of the photodiode 7, because the visible light generated in the scintillator layer 31 exposed to X-rays is reflected toward the photodiode 7 by the reflective layer 42 containing titanium oxide powder in a thermoplastic polymer compound in an amount of 70 wt % or more.

Further, the reflective layer 42, which has a composition consisting of a thermoplastic polymer compound and a titanium oxide powder contained in an amount of 70 wt % or more therein, can be formed easily on the scintillator layer 31, for example, by a simple coating method. Then, it is possible to form a protective layer 41 having a three-layered structure by bonding a composite film of an adhesive layer 43 and a moisture-proof layer 44 onto a reflective layer 42. As a result, it is possible to form a protective layer 41 having a reflective layer 42 that is free from defects such as pinholes, without any large-scale facilities, such as those needed for production of a protective layer of conventional deposition film.

Accordingly, it is possible to provided an X-ray detector that retains its high sensitivity and high resolution for an extended period of time, because it is possible to prevent penetration of moisture into the scintillator layer 31, to prevent degradation of the scintillator layer 31 and also of the resolution and luminous efficiency thereof in an acceleration test under high-temperature and high-humidity condition, and to improve the photoelectric conversion efficiency of the photodiode 7 by emitting the visible light generated in the scintillator layer 31 toward the photoelectric conversion element (photodiode) 7 efficiently.

### Second Embodiment

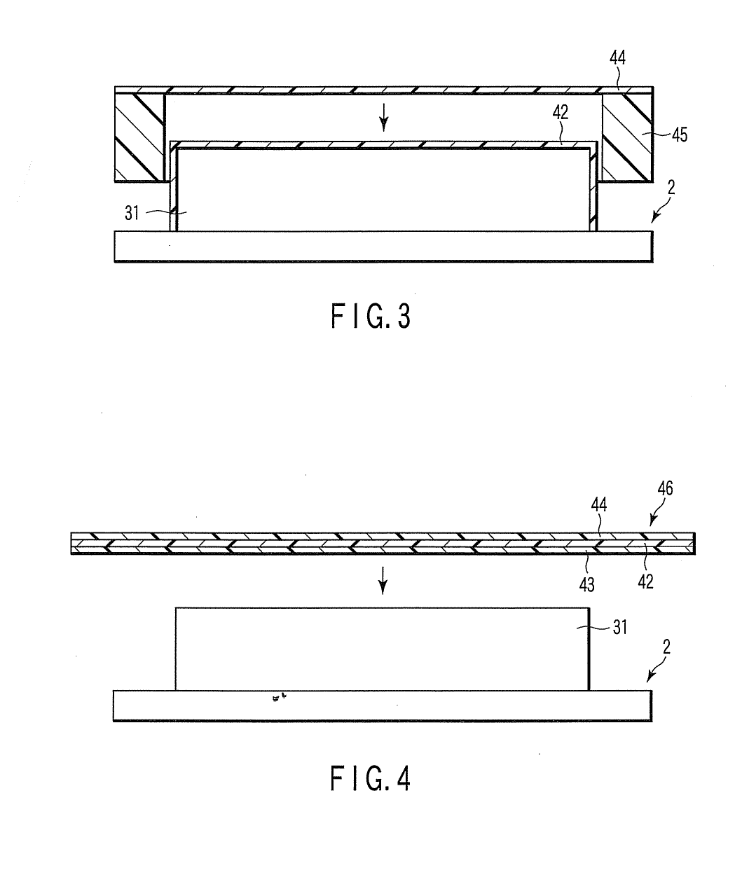

FIG. 3 is a schematic sectional view illustrating the step of forming a protective layer for the scintillator layer of the radiation ray detector (e.g., X-ray detector) in a second embodiment. The members in FIG. 3 similar to those described in FIGS. 1 and 2 above are indicated with the same numbers, and a duplicated description is omitted.

The X-ray detector in the second embodiment has a structure wherein a reflective layer 42 is formed on an electrode substrate 2 including a scintillator layer 31 (photoconverting substrate) by, in advance, applying the above mentioned paint for reflective layer containing a thermoplastic polymer compound and a titanium oxide powder contained therein in an amount of 70 wt % or more, and a protective layer is formed by adhering a moisture-proof layer 44 having a moisture transmittance of 0.5 g/m²/day or less at 40° C. and 90% RH including a frame-shaped adhesive layer 45 on the periphery of the surface in such a manner that the frame-shaped adhesive layer 45 is located on the side wall of the scintillator layer 31 including reflective layer 42 and the surface of the photoconverting substrate 2.

In the second embodiment, it is possible to prevent penetration of moisture from the terminal side wall of the protective layer into the scintillator layer 31 more reliably than the protective layer in the first embodiment described above, by forming the moisture-proof layer 44 on the photoconverting substrate 2 including the scintillator layer 31 covered with the reflective layer 42, by using the frame-shaped adhesive layer 45. Accordingly, it is possible to prevent degradation of the scintillator layer 31 for an extended period of time in an acceleration test under high-temperature and high-humidity conditions, and thus, to provide an X-ray detector allowing preservation of its high sensitivity and resolution for a lengthened period of time.

### Third Embodiment

FIG. 4 is a schematic sectional view illustrating the step of forming a protective layer for a scintillator layer in the radiation ray detector (e.g., X-ray detector) in a third embodiment. The members in FIG. 4 similar to those described in FIGS. 1 and 2 above are indicated with the same numbers, and a duplicated description is omitted.

The radiation ray detector in the third embodiment has a structure wherein a protective layer is formed on an electrode substrate (photoconverting substrate) 2 including a scintillator layer 31 by adhering thereto a multilayered resin film 46 consisting of an adhesive layer 43, a reflective layer 42 containing titanium oxide powder in a thermoplastic polymer compound in an amount of 70 wt % or more, and a moisture-proof layer 44 having a moisture transmittance of 0.5 g/m²/day or less at 40° C. and 90% RH. Such a multilayered resin film 46 is preferably adhered under reduced pressure.

In the third embodiment, it is possible to prevent moisture penetration into the scintillator layer 31 with the moisture-proof layer 44 and also to form a protective layer more easily than that in the first embodiment described above, by adhering the multilayered resin film 46 to the electrode substrate (photoconverting substrate) 2 including the photoconductive layer 31 via the adhesive layer 43.

### Fourth Embodiment

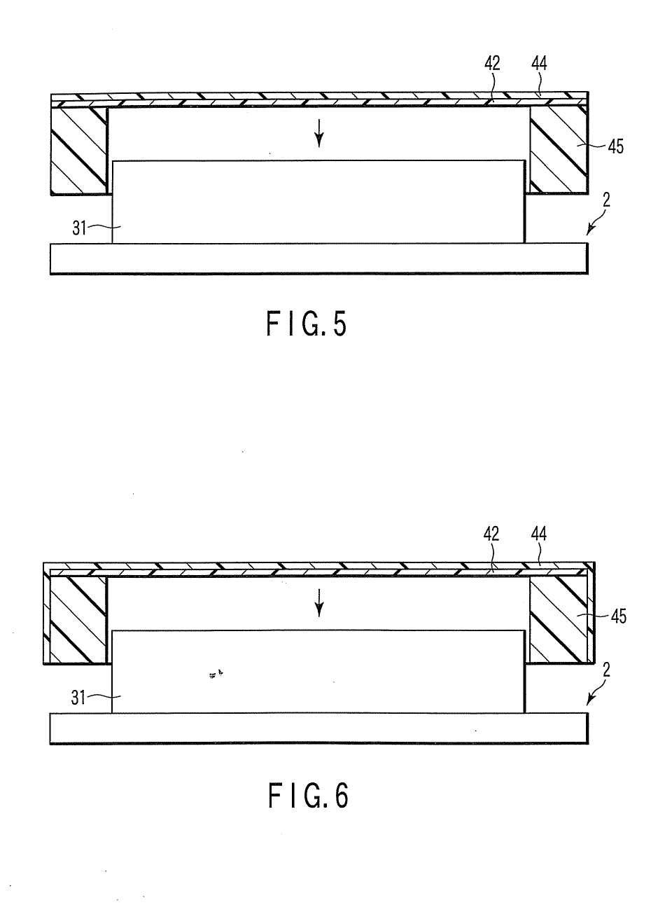

FIG. 5 is a schematic sectional view illustrating the step of forming a protective layer for a scintillator layer in the radiation ray detector (e.g., X-ray detector) of a fourth embodiment. The members in FIG. 5 similar to those described in FIGS. 1 and 2 above are indicated with the same numbers, and a duplicated description is omitted.

The radiation ray detector in the fourth embodiment has a structure wherein a protective layer is formed by adhering thereto a reflective layer 42 containing titanium oxide powder in a thermoplastic polymer compound in an amount of 70 wt % or more carrying a frame-shaped adhesive layer 45 on the peripheral of the surface of an electrode substrate (photoconverting substrate) 2 including a scintillator layer 31 and a moisture-proof layer 44 having a moisture transmittance of 0.5 g/m²/day or less at 40° C. and 90% RH, laminated to the reflective layer 42, in such a manner that the frame-shaped adhesive layer 45 is located on the surface of the electrode substrate 2 and the side wall of the scintillator layer 31.

In the fourth embodiment, it is possible to prevent penetration of moisture from the terminal side wall of the protective layer into the scintillator layer 31 more reliably than the protective layer in the structure shown in FIG. 4 described above, by protecting the photoconverting substrate 2 including the scintillator layer 31 by adhering the multilayered reflective layer 42 and the moisture-proof layer 44 with the frame-shaped adhesive layer 45. It is thus possible to prevent degradation of the scintillator layer 31 in an acceleration test under high-temperature high-humidity condition for an extended period of time and thus, to provide an X-ray detector allowing preservation of its high sensitivity and resolution for a further extended period of time.

In the fourth embodiment, as shown in FIG. 6, a protective layer may be formed by laminating the moisture-proof layer 44 not only onto the reflective layer 42 but also onto the external surface of the frame-shaped adhesive layer 45. In such a structure, because the moisture-proof layer 44 is laminated on the external surface of the frame-shaped adhesive layer 45 additionally, it is possible to prevent moisture penetration into the scintillator layer 31 more reliably than with the protective layer shown in FIG. 5 described above.

In the second to fourth embodiments above, by reducing the modulus of the adhesive layer 43 (or frame-shaped adhesive layer 45) directly in contact with the scintillator layer 31, it is possible to reduce stress concentration by the adhesive layer 43 in direct contact with the scintillator layer 31, to preserve stabilized adhesive strength for an extended period of time, and thus, to use a larger-sized glass plate 3.

Hereinafter, examples of the present invention will be described in detail.

### EXAMPLE 1

90 wt % of a titanium oxide powder having an average diameter of 0.25 μm and 10 wt % of a butyral resin (trade name: S-LEC BMS, manufactured by Sekisui Chemical Co., Ltd.) were mixed with cyclohexanone in a rotational/revolutional mixer, and the mixture was dispersed uniformly by using a homogenizer, to prepare a paint for a reflective layer in advance.

Then, a CsI converting film layer (scintillator layer) having a thickness of 600 μm was formed on a glass plate (trade name: Corning 1737, manufactured by Corning Incorporated). The paint for the reflective layer was applied and dried on the surface and side wall of the scintillator layer by using a dispenser, to form a reflective layer having a thickness of 100 μm. Subsequently, a multilayered resin film consisting of a moisture-proof layer having a thickness of 80 μm (trade name: GX film, manufactured by Toppan Printing Co., Ltd.) and an acrylic double-faced adhesive having a thickness of 0.6 mm (trade name: S-0679, manufactured by Soken Chemical & Engineering Co., Ltd.) adhered to one face thereof as an adhesive layer was bonded to the surface of the glass plate carrying the reflective layer to form a protective layer.

### EXAMPLE 2

90 wt % of a titanium oxide powder having an average diameter of 0.25 μm and 10 wt % of a butyral resin (trade name: S-LEC BMS, manufactured by Sekisui Chemical Co., Ltd.) were mixed with cyclohexanone in a rotational/revolutional mixer, and the mixture was dispersed uniformly by using a homogenizer, to prepare a paint for a reflective layer in advance.

A CsI converting film layer (scintillator layer) having a thickness of 600 μm was formed on a glass plate (trade name: Corning 1737, manufactured by Corning Incorporated). The paint for the reflective layer was applied and dried on the surface and side wall of the scintillator layer by using a dispenser, to form a reflective layer having a thickness of 100 μm. Subsequently, an acrylic double-faced adhesive having a thickness of 0.7 mm (trade name: S-0779, manufactured by Soken Chemical & Engineering Co., Ltd.) was adhered in a frame-shaped pattern to the peripheral edge of one surface of a moisture-proof layer having a thickness of 80 μm (trade name: GX film, manufactured by Toppan Printing Co., Ltd.), and the composite film was bonded via the frame-shaped adhesive layer onto the surface of the glass plate carrying the reflective layer to form a protective layer.

### EXAMPLE 3

80 wt % of a titanium oxide powder having an average diameter of 0.2 μm and 20 wt % of a butyral resin (trade name: S-LEC BMS, manufactured by Sekisui Chemical Co., Ltd.) were mixed with cyclohexanone in a rotational/revolutional mixer, and the mixture was dispersed uniformly by using a homogenizer, to prepare a paint for the reflective layer in advance. The paint for the reflective layer was applied and dried on one face of a moisture-proof layer having a thickness of 80 μm (trade name: GX film, manufactured by Toppan Printing Co., Ltd.) by using a bar coater, to form a reflective layer having a thickness of 100 μm. Subsequently, as an adhesive payer, an acrylic double-faced adhesive having a thickness of 0.7 mm (trade name: S-0779, manufactured by Soken Chemical & Engineering Co., Ltd.) was adhered to the reflective layer to form a multilayered resin film.

Then, a CsI converting film layer (scintillator layer) having a thickness of 600 μm was formed on a glass plate (trade name: Corning 1737, manufactured by Corning Incorporated). The multilayered resin film was adhered via the adhesive layer onto the surface of the glass plate including the surface and side wall of the scintillator layer, to form a protective layer.

### EXAMPLE 4

80 wt % of a titanium oxide powder having an average diameter of 0.2 μm and 20 wt % a butyral resin (trade name: S-LEC BMS, manufactured by Sekisui Chemical Co., Ltd.) were mixed with cyclohexanone in a rotational/revolutional mixer, and the mixture was dispersed uniformly by using a homogenizer, to prepare a paint for the reflective layer in advance. The paint for the reflective layer was coated and dried on one face of a moisture-proof layer having a thickness of 80 μm (trade name: GX film, manufactured by Toppan Printing Co., Ltd.) by using a bar coater, to form a reflective layer having a thickness of 100 μm. An acrylic double-faced adhesive having a thickness of 0.7 mm (trade name: S-0779, manufactured by Soken Chemical & Engineering Co., Ltd.) was then adhered in the frame-shaped pattern to the peripheral edge of one surface of the reflective layer, to give a multilayered resin film having a frame-shaped adhesive layer.

Then, a CsI converting film layer (scintillator layer) having a thickness of 600 μm was formed on a glass plate (trade name: Corning 1737, manufactured by Corning Incorporated). The multilayered resin film was adhered to the surface of the glass plate including the surface and side wall of the scintillator layer via the frame-shaped adhesive layer, to give a protective layer.

### EXAMPLE 5

80 wt % of a titanium oxide powder having an average diameter of 0.2 μm and 20 wt % a butyral resin (trade name: S-LEC BMS, manufactured by Sekisui Chemical Co., Ltd.) were mixed with cyclohexanone in a rotational/revolutional mixer, and the mixture was dispersed uniformly by using a homogenizer, to prepare a paint for the reflective layer in advance. The paint for the reflective layer was coated and dried on one face of a moisture-proof layer having a thickness of 80 μm (trade name: GX film, manufactured by Toppan Printing Co., Ltd.) with the periphery edge of the face remaining exposed by using a bar coater, to form a reflective layer having a thickness of 100 μm. An acrylic double-faced adhesive having a thickness of 0.7 mm (trade name: S-0779, manufactured by Soken Chemical & Engineering Co., Ltd.) was then adhered in the frame-shaped pattern to the peripheral edge of the reflective layer surface, and the reflective layer-unformed region on the peripheral edge of the moisture-proof layer was adhered to the side wall of the frame-shaped adhesive layer as it is bent, to give a multilayered resin film.

Then, a CsI converting film layer (scintillator layer) having a thickness of 600 μm was formed on a glass plate (trade name: Corning 1737, manufactured by Corning Incorporated). The multilayered resin film was bonded onto the surface of the glass plate including the surface and side wall of the scintillator layer via the frame-shaped adhesive layer, to prepare a protective layer. The bonding was performed in a vacuum dryer at 60° C.

### COMPARATIVE EXAMPLE 1

A CsI converting film layer (scintillator layer) having a thickness of 600 μm was formed on a glass plate (trade name: Corning 1737, manufactured by Corning Incorporated). Subsequently, a parylene-deposited film having a thickness of 40 μm was formed as a moisture-proof layer on the surface of the glass plate including the surface and side wall of the scintillator layer, and the terminal of the parylene deposition film was processed with a two-component thermosetting epoxy resin, to form a protective layer.

The moisture transmittance, the water absorption of the scintillator layer, the retention rate of resolution and the change in shape of the scintillator layer by moisture absorption of the protective layers obtained in Examples 1 to 5 and Comparative Example 1 were determined according to the following methods.

1. Measurement of the Moisture Transmittance of Protective Layer

A region of each the protective layers used in Examples 1 to 5 and Comparative Example 1 is chosen from portion where there is no scratching, void, or folding, and then an amount of water absorption in the region was determined from the mass change during storage under an atmosphere at 40° C. and a humidity of 90% by using a moisture transmittance analyzer manufactured by MOCON Inc., U.S. The moisture transmittance was calculated from the results.

2. Measurement of the Water Absorption Rate of Scintillator Layer

Each of the protective layers used in Examples 1 to 5 and Comparative Example 1 was formed on a glass plate and left under an environment at 60° C. and 90% RH for 500 hours, and the water absorption rate then was determined.

3. Measurement of the Retention Rate of Resolution

Each of the samples of Examples 1 to 5 and Comparative Example 1 having a protective layer formed on a scintillator layer on glass plate was left under an environment at 60° C. and 90% RH for 500 hours, and measurement of a contrast transfer function (CTF) as an indicator of the definition of an X-ray image was performed under X-ray irradiation conditions of an accelerating voltage of 70 kV-1 mA with an aluminum filter for removal of soft X-rays inserted, by using a resolution chart at a density of two pairs of line-and-spaces at a 1-mm interval, and the change from the initial value was determined to use it as the retention rate.

4. Result of SEM Observation of Scintillator Layer

Each of the samples of Examples 1 to 5 and Comparative Example 1 having a protective layer formed on a scintillator layer of glass plate was left under an environment at 60° C. and 90% RH for 500 hours, and the protective layer was removed and the shape of the scintillator layer was observed under a SEM.

These results are summarized in the following Table 1.

TABLE 1

| | Moisture | | | Results of |
|---|---|---|---|---|
| | transmittance | Water absorp- | Retention | SEM obser- |
| | of protective | tion rate of | rate | vation on |
| | layer | scintillator | of resolu- | scintillator |
| | (g/m²-day) | layer (%) | tion (%) | layer |
| Example 1 | 0.01 | 0.03 | 98 | No change |
| Example 2 | 0.20 | 0.05 | 95 | No change |
| Example 3 | 0.02 | 0.02 | 98 | No change |
| Example 4 | 0.13 | 0.06 | 95 | No change |
| Example 5 | 0.01 | 0.02 | 98 | No change |
| Comparative | 50 | 4.5 | 10 | Deliques- |
| Example 1 | | | | cence |
| | | | | observed |

As apparent from Table 1, the protective layers obtained in Examples 1 to 5 were more resistant to moisture penetration and had a higher retention rate of resolution than the protective layer of Comparative Example 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radiation ray detector, comprising:
an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;
a scintillator layer formed on the electrode substrate to convert radiation rays into visible light; and
a protective layer comprising at least a reflective layer formed on the scintillator layer and containing a thermoplastic polymer compound and a titanium oxide powder contained therein in an amount of 70 wt % or more, an adhesive layer formed on the surface of the electrode substrate including the reflective layer, and a moisture-proof layer adhered to the adhesive layer and having a moisture transmittance of 0.5 g/m²/day or less at 40° C. and 90% RH.

2. The detector according to claim 1, wherein the thermoplastic polymer compound in the reflective layer is a butyral or acrylic resin.

3. The detector according to claim 1, wherein the titanium oxide powder in the reflective layer has an average diameter of 0.1 to 1 μm.

4. The detector according to claim 1, wherein the adhesive layer is selected from an acrylic adhesive, a silicone-based adhesive or a butyl rubber-based adhesive that is tacky at room temperature.

5. The detector according to claim 1, wherein the moisture-proof layer is an inorganic material-deposited resin film.

6. A radiation ray detector, comprising:
an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;
a scintillator layer formed on the electrode substrate to convert radiation rays into visible light; and
a protective layer comprising at least a reflective layer formed on the scintillator layer and containing a thermoplastic polymer compound and a titanium oxide powder contained therein in an amount of 70 wt % or more, a frame-shaped adhesive layer bonded to the reflective layer on the surface of the electrode substrate surface and the side wall of the scintillator, and a moisture-proof layer having a moisture transmittance of 0.5 g/m²/day or less at 40° C. and 90% RH adhered to the frame-shaped adhesive layer.

7. The detector according to claim 6, wherein the thermoplastic polymer compound in the reflective layer is a butyral or acrylic resin.

8. The detector according to claim 6, wherein the titanium oxide powder in the reflective layer has an average diameter of 0.1 to 1 μm.

9. The detector according to claim 6, wherein the adhesive layer is selected from an acrylic adhesive, a silicone-based adhesive or a butyl rubber-based adhesive that is tacky at room temperature.

10. The detector according to claim 6, wherein the moisture-proof layer is an inorganic material-deposited resin film.

11. A radiation ray detector, comprising:
an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;
a scintillator layer formed on the electrode substrate to convert radiation rays into visible light; and
a protective layer comprising an adhesive layer to be adhered to the electrode substrate including the scintillator layer, a reflective layer adhered to the adhesive layer and containing a thermoplastic polymer compound and a titanium oxide powder contained therein in an amount of 70 wt % or more, and a moisture-proof layer laminated to the reflective layer and having a moisture transmittance of 0.5 g/m²/day or less at 40° C. and 90% RH.

12. The detector according to claim 11, wherein the thermoplastic polymer compound in the reflective layer is a butyral or acrylic resin.

13. The detector according to claim 11, wherein the titanium oxide powder in the reflective layer has an average diameter of 0.1 to 1 μm.

14. The detector according to claim 11, wherein the adhesive layer is selected from an acrylic adhesive, a silicone-based adhesive or a butyl rubber-based adhesive that is tacky at room temperature.

15. The detector according to claim 11, wherein the moisture-proof layer is an inorganic material-deposited resin film.

16. A radiation ray detector, comprising:
an electrode substrate comprising a transparent substrate, a plurality of thin film transistors formed on the transparent substrate, a plurality of collecting capacitors formed on the transparent substrate, an insulation layer formed on the transparent substrate including these thin film transistors and collecting capacitors, and a plurality of photoelectric conversion elements connected to respective thin film transistors and converting visible light into an electrical signal;
a scintillator layer formed on the electrode substrate to convert radiation rays into visible light; and
a protective layer comprising a frame-shaped adhesive layer adhered to the surface of the electrode substrate and the side wall of the scintillator layer, a reflective layer adhered to the adhesive layer, containing a thermoplastic polymer compound and a titanium oxide powder contained therein in an amount of 70 wt % or more, and a moisture-proof layer laminated onto the reflective layer and having a moisture transmittance of 0.5 g/m²/day or less at 40° C. and 90% RH.

17. The detector according to claim 16, wherein the thermoplastic polymer compound in the reflective layer is a butyral or acrylic resin.

18. The detector according to claim 16, wherein the titanium oxide powder in the reflective layer has an average diameter of 0.1 to 1 μm.

19. The detector according to claim 16, wherein the adhesive layer is selected from an acrylic adhesive, a silicone-based adhesive or a butyl rubber-based adhesive that is tacky at room temperature.

20. The detector according to claim 16, wherein the moisture-proof layer is an inorganic material-deposited resin film.
